(19) United States
(12) Patent Application Publication
(10) Pub. No.: US 2005/0220542 A1
(43) Pub. Date: Oct. 6, 2005

(54) Landfill cover composition and method

(76) Inventors: Danny L. Marsh, Tyler, TX (US); John Nelson, Troup, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/814,439

(22) Filed: Mar. 31, 2004

(51) Int. Cl. B09B 5/00

(52) U.S. Cl. 405/129.9; 405/129.95

(57) ABSTRACT

A landfill cover composition comprising a concentrate formulated to include a hardening agent, a thickener and emulsifier, and a super absorbent polymer, mixable with water and a filler material, such as cellulose or wood fiber mulch. A mixture of water, filler material and concentrate is sprayed on the surface of a landfill refuse layer and hardened to provide at least a temporary cover as an alternative to a significantly thicker or deeper layer of conventional soil or earth cover. The biodegradable composition preferably includes Plaster of Paris and guar gum compositions and cross-linked sodium acrylate polymer fines, mixed with the filler material and water at a landfill site for reducing transportation and handling costs.

### BACKGROUND OF THE INVENTION

The rapid development and growth of refuse landfills worldwide has brought an increase in the need to provide suitable protective cover layers between layers of compacted refuse. Typical landfill operations are carried out by compacting a layer of refuse of predetermined depth or thickness, such as what might be deposited and compacted during a typical work day. Once a predetermined depth of refuse has been deposited and compacted, typically, a layer of earth is deposited over the layer of compacted refuse. The layer of earth may be on the order of 0.5 to 1.0 foot thick so as to provide a suitable protective cover that will not expose the compacted refuse layer directly to the environment and pests. However, in many landfill operations, a sufficient amount of earth to provide the landfill cover layers is not available due to the topographic conditions or where suitable soil is not readily available in the vicinity of the landfill. Moreover, the required depth or thickness of earth cover layers reduces the amount of space available for refuse layer thickness or depth.

As a consequence of the above-mentioned problems with landfill operations, including situations wherein it is desirable to reduce the thickness of the landfill cover layer, thereby providing more space for disposal of refuse, collectively, landfill cover compositions have been developed to replace earth or soil layers of landfill cover, which cover compositions facilitate decomposition of the refuse, alleviate odors and repel vermin. Known types of landfill cover compositions may be applied to a refuse layer in a landfill by mixing a prepackaged dry mixture with water and spraying the resultant slurry onto the surface of the landfill refuse layer using conventional hydraulic mulching or seeding machinery, for example.

However, there has been a continuing need to reduce the costs associated with the use of alternative landfill cover compositions, such as the general type described above. For example, in many refuse landfill operations, landfill cover composition filler material, such as cellulose from recycled paper or wood pulp fiber, may be provided locally in the vicinity of the landfill, is otherwise readily available, or may be shipped to the landfill site over a shorter distance and, consequently, at reduced cost. Accordingly, there has been a recent need and desire to provide a landfill cover composition in the form of a concentrate which may be mixed at the point of application with water and filler material, such as recycled paper and wood fiber mulch. It is to these ends that the present invention has been developed.

### SUMMARY OF THE INVENTION

The present invention provides an improved composition, particularly adapted for use in providing cover layers over layers of refuse in landfills and the like. The present invention also provides an improved method of providing a landfill cover composition applicable to a refuse landfill for use in place of cover materials, such as earth.

In accordance with one aspect of the present invention, a landfill cover composition is provided which includes a binder and hardening agent, an economical thickener and stabilizer which hydrates rapidly, and a gel-forming substance which also expands and aids in forming a matrix-like composition when mixed with a filler material. The above-mentioned composition may be provided as a so-called concentrate which may also be pre-mixed with at least a certain amount of fibrous filler material. Additional ingredients may include a deodorant carried on a fiber host, for example. Ingredients may be supplied in proportions which provide the so-called concentrate which may be mixed with water and substantial quantities of additional filler material, such as cellulose or wood pulp fibers, such that a composition is provided which forms a superior landfill cover, which may be used in place of earth or otherwise available manmade landfill cover compositions.

The present invention also contemplates a method of providing a landfill cover, which includes a composition in accordance with the invention, which may be transported and manipulated more easily than compositions that are premixed with filler materials, since handling and long distance transportation of filler material may not be required in many applications of landfill cover compositions. In other words, where filler materials, such as cellulose and wood pulp fiber, for example, are available near a landfill or may be shipped by bulk transport equipment more economically than shipping the filler material premixed with a binder and hardener, the composition and method in accordance with the present invention provides for a superior landfill cover composition and method of application at reduced cost and satisfies a need which is becoming increasingly acute.

Those skilled in the art will further appreciate the above-mentioned features and advantages of the invention, together with other important aspects thereof, upon reading the detailed description which follows.

### DETAILED DESCRIPTION OF THE PREFERRED EMBODIMENTS

The present invention contemplates the provision of a composition in the form of a concentrate comprising a premixed quantity of ingredients to be described herein which may be packaged in conventional shipping bags or other types of containers and having a weight of about 40 pounds per container. This size container is more easily handled for transport and for discharging the composition into suitable mixing and application equipment. In certain landfill operations, hydraulic, so-called hydro-mulching, mixing and pumping equipment may be used to apply a landfill cover composition in accordance with Applicants' invention. For example, slurry mixing and pumping apparatus available from Bowie Industries, Inc. of Bowie, Tex., FINN Corporation of Fairfield, Ohio, or Kincaid Equipment Manufacturing of Haven, Kans., may be used to mix and apply the composition of the invention as a landfill cover composition. Such equipment may be truck or trailer mounted for traversing over landfill operations to apply the composition of the invention to a compacted layer of refuse prior to application of the next refuse layer thereover. Such equipment typically includes a motor driven slurry pump connected to a tank which includes suitable mechanical agitating or mixing equipment mounted therein. The composition or concentrate of the present invention may be thoroughly mixed with water and a filler material, such as cellulose or wood pulp fiber, and then pumped through a nozzle mounted on the aforementioned equipment for covering a landfill refuse layer.

Certain landfill cover materials currently commercially available, including Waste Cover brand daily landfill cover composition available from Southwest Environment Services, Inc. of Tyler, Tex., are typically mixed in a ratio of one 50 pound bag of the waste cover composition to about 70 gallons of water. Such a composition will cover approximately 450 square feet of the surface of a refuse layer to a cover layer thickness of about 0.25 inches to 0.50 inches and will typically satisfy the requirements for landfill covers for at least temporary or daily operations. The aforementioned landfill cover composition, when applied to the surface of a compacted layer of refuse, will satisfy the requirements for a landfill layer cover for at least a period of up to fourteen days.

However, the present invention has been developed in order to provide a more economical and efficient landfill cover composition which includes filler materials, such as cellulose or wood pulp, and which may be available locally in the vicinity of the landfill or which filler materials may be transported in bulk, for example, or over relatively short distances. A composition comprising a so-called concentrate is provided for mixing on-site with filler material, such as cellulose and/or wood fiber mulch, to thereby alleviate the expense and nuisance of shipping such filler material over long distances. To this end, Applicants have developed a composition which may be mixed with a filler, such as cellulose and/or wood fiber mulch, and water on-site and in equipment of the type described above. For example, by providing a 40 pound container or bag of a composition concentrate in accordance with the invention, mixed with 50 pounds of cellulose and/or wood fiber mulch, and 55 gallons of water, a landfill cover composition is provided having a total area coverage of about 900 square feet. The rate of application and/or area covered may vary in accordance with the thickness of the layer of cover required by various landfill operators and local governmental regulations, but the coverage rate described above is meaningful for comparison purposes. Accordingly, a substantially reduced quantity of water and a lower total weight of composition ingredients may be required for covering essentially the same surface area of refuse layer as is obtainable with prior art compositions.

The composition of the invention may be considered as a so-called concentrate which, when mixed with filler material, such as cellulose and/or wood fiber mulch, and a predetermined quantity of water will provide a landfill cover composition which will cover a larger area than prior art compositions, while providing the same covering function, namely, a non-toxic biodegradable landfill cover which is easy to mix and spray, is non-flammable, controls blowing litter and debris, controls odor and disease emission and transmission, is aesthetically acceptable, repels certain vermin, and eliminates fine powders and dust and may be applied using conventional hydraulic mulching equipment, for example.

The composition of the invention includes a hardening and binding agent consisting of plaster, such plaster resulting from the calcination of gypsum (chemical family, calcium sulphate hemihydrate). The hardening and binding agent may be conventional Plaster of Paris, or provided in a specific blend of 90 percent by weight of Plaster of Paris, 5.0 percent by weight of a proprietary blend of ingredients and 5.0 percent by weight of crystalline silica and known as S.W.E. Special by vendor United States Gypsum Company of Chicago, Ill. Hereinafter, the hardening and binding agent will be referred to as Plaster of Paris and is provided in the composition concentrate of the invention as about 75 percent by weight of the composition concentrate and may be provided with 4.0 percent by weight of fibers.

The so-called concentrate of the invention further includes guar gum in the amount of about 2.5 to 3.0 percent by weight as an economical thickener and stabilizer which hydrates fairly rapidly in cold water to provide a viscous pseudo-plastic solution of generally greater low-shear viscosity compared with other hydrocolloids. Higher concentrations in the range of about 10 percent are possible, but may tend to create a thixotropic mixture. Preferably, the guar gum used in the concentrate of the invention is a guar compound commercially available from Benchmark Polymer Products, L.P. of Dalton, Ga., and known as Enviro-Tak Plus/Guar Gum, hereinafter referred to as guar gum. A thickener and stabilizer, such as guar gum, will also retard ice crystal growth by slowing mass transfer across solid/liquid interfaces. The guar gum ingredient also provides elasticity to the dried and hardened cover composition as well as adherence of the composition to the surface of an underlying refuse layer. Moreover, the provision of guar gum, as indicated, provides improved solubility, dispersiveness and emulsification of a mixture of the concentrate of the invention with the filler material, such as cellulose and/or wood fiber mulch.

Still further, the composition or concentrate of the invention includes a quantity of super absorbent polymer, preferably comprising cross-linked sodium acrylate polymer fines also provided in a quantity of at least about 2.5 to 3.0 percent by weight of the concentrate. The addition of the cross-linked sodium acrylate super absorbent polymer fines improves the gelation of the composition, when mixed with water and a filler, such as cellulose or wood fiber mulch, and provides a mechanism for swelling of the landfill cover composition once applied to the landfill, which is advantageous. The super absorbent polymer material used in the composition of the invention may be essentially similar to that used in super absorbent diapers. Commercial sources for cross-linked sodium acrylate polymer fines include Surplus Unlimited of Whitehouse, Tex., under the product designation L-500 super absorbent polymer and Nippon Shokubai Company, Ltd. of Osaka, Japan.

The concentrate of the invention may further include about 2.5 to 3.0 percent by weight of a waste or refuse degrading composition, including a proprietary enzyme matrix and a deodorant provided on a wood fiber host and of a type commercially available, such as from AgPro Systems, Inc. of Big Sandy, Tex., as their product designation OC1000.

Lastly, the composition of the concentrate of the invention may include a quantity of wood pulp fiber having approximately 3.0 percent super absorbent polymer mixed therein. The wood pulp fiber and super absorbent polymer mixture, also commercially available from Surplus Unlimited, may be provided in a weight range of 0 to about 17.5 percent by weight of the total concentrate and used as a combination matrix former and filler in the concentrate, as well as an expansion agent. If the wood pulp fiber and super absorbent polymer ingredient is not included in the concentrate, the percentages by weight of the hardening agent (Plaster of Paris), the emulsifier (guar gum), the super absorbent polymer fines, and the deodorant would be about 91 percent, 3.0 percent, 3.0 percent and 3.0 percent by weight, respectively.

As mentioned previously, the above-described composition may be provided as a mixture in containers, such as 40 pound bags or similar containers, and shipped to a site for application using a type of equipment as previously described. The proportion of concentrate in the total composition mixture is preferably about 6.0 to 7.3 percent by weight, the proportion of filler material is about 9.0 to 10.4 percent by weight and the remainder being water. For example, a mixture of the concentrate of the invention in the amount of 40 pounds with 50 pounds of cellulose and/or wood fiber mulch with 55 gallons of water, thoroughly mixed in a mixing tank of an apparatus as described above and sprayed onto a compacted or non-compacted layer of refuse in a landfill, will cover a surface area of approximately 900 square feet suitably to function as daily cover for refuse layers in landfill operations. Thanks to the provision of a hardening agent, such as calcium sulfate hemihydrate, which provides hardness to the cover layer material, and the provision of a thickener and emulsifier, such as guar gum, and further thanks to the provision of a super absorbent polymer, which provides for gelation and expansion of the composition when applied to the surface of a landfill refuse layer, the overall composition, including a filler material, provides a superior, rapidly hardenable, cohesive, sheet-like layer for covering a landfill refuse layer in an advantageous manner. Still further, the super absorbent polymer contributes to the volumetric expansion of the layer of landfill cover, which provides a suitable thickness of the cover, but which thickness is substantially less than the thickness of a cover layer, which would be required if conventional soil materials were used.

A preferred process of applying a landfill cover composition in accordance with the invention includes utilization of mixing and application equipment of the type described above. Typically, the holding and mixing tank of the mixing and application equipment is filled approximately half full of water, at which time filler material, such as cellulose and/or wood fiber mulch, is added to the tank. This operation is followed by application of the landfill cover composition concentrate in accordance with the invention, all of the ingredients of the mixture in the tank being in the proportions described herein.

After thorough mixing of the composition, requiring approximately ten minutes of mixing time, the landfill cover composition is sprayed onto a layer of refuse material in a thorough wetting and covering spray. As the ingredients of the composition react, the composition hardens into a stable and structurally sound matrix-like layer approximately 0.25 inches to 0.5 inches thick and is suitable for landfill cover for at least temporary purposes, including daily or even weekly periods of time. The setting or hardening time for the composition is typically about thirty minutes after being sprayed onto the surface of a landfill refuse layer.

Those skilled in the art will appreciate from the foregoing description that an improved landfill cover composition has been developed in accordance with the present invention, together with an improved method of providing for and applying such a composition which reduces the costs associated with providing and transporting the composition to a work site. By providing a concentrate which may be mixed with a filler material at the site of application, costs associated with providing landfill covers are reduced, operations are simplified and a substantially biodegradable and at least temporary landfill cover composition is provided.

Those skilled in the art will also recognize that the composition and method of the present invention may be modified and certain substitutions may be provided without departing from the scope and spirit of the appended claims.

1. A landfill cover composition comprising a concentrate characterized by a hardening agent, a thickener and emulsifier, and a super absorbent polymer for mixing with water and a filler material for application as at least temporary cover for a landfill refuse layer.

2. The composition set forth in claim 1 wherein:
said hardening agent comprises Plaster of Paris.

3. The composition set forth in claim 1 wherein:
said thickener and emulsifier comprises guar gum.

4. The composition set forth in claim 1 wherein:
said super absorbent polymer comprises cross-linked sodium acrylate polymer.

5. The composition set forth in claim 1 wherein:
said filler material comprises a biodegradable material selected from a group consisting of cellulose and wood fiber mulch.

6. The composition set forth in claim 1 wherein:
said concentrate is provided in dry bulk containers comprising about 75 to 91 percent by weight of hardening agent, 2.5 to 3.0 percent by weight of thickener and emulsifier, and 2.5 to 3.0 percent by weight of super absorbent polymer.

7. The composition set forth in claim 6 wherein:
said concentrate includes a quantity of biodegradable dry mulch in the amount of about 0 to 18 percent by weight.

8. The composition set forth in claim 6 including:
a refuse degrading agent in the amount of 2.50 to 3.0 percent by weight of said concentrate.

9. The composition set forth in claim 1 wherein:
said concentrate is provided in an amount of about 6.0 to 7.3 percent by weight of a mixture of said concentrate, said filler material and water.

10. The composition set forth in claim 9 wherein:
said filler material is provided in the amount of about 9.0 to 10.4 percent by weight of said mixture.

11. A landfill cover composition comprising a concentrate characterized by a hardening agent, a thickener and emulsifier, and a super absorbent polymer for mixing with water and a filler material for application as at least temporary cover for a landfill refuse layer wherein said hardening agent comprises a Plaster of Paris composition, said thickener and emulsifier comprises a guar gum composition, and said super absorbent polymer comprises cross-linked sodium acrylate polymer.

12. The composition set forth in claim 11 wherein:
said filler material comprises a biodegradable material selected from a group consisting of cellulose and wood fiber mulch.

13. The composition set forth in claim 11 wherein:
said concentrate is provided in dry bulk containers comprising about 75 to 91 percent by weight of hardening agent, 2.5 to 3.0 percent by weight of thickener and emulsifier, and 2.5 to 3.0 percent by weight of super absorbent polymer.

14. The composition set forth in claim 13 wherein:
said concentrate includes a quantity of biodegradable dry mulch in the amount of about 0 to 17.5 percent by weight.

15. A liquefied sprayable landfill cover composition comprising a mixture of a concentrate comprising a Plaster of Paris hardening agent, a guar gum thickener and emulsifier and a super absorbent polymer, water and a filler material selected from a group consisting of cellulose and wood fiber mulch for application as at least temporary cover for a landfill refuse layer.

16. The composition set forth in claim 15 including:
a refuse degrading agent.

17. The composition set forth in claim 15 wherein:
said concentrate is provided in an amount of about 6.0 to 7.3 percent by weight of said mixture.

18. The composition set forth in claim 15 wherein:
said filler material is provided in an amount of about 9.0 to 10.4 percent by weight of said mixture.

19. A method of providing an at least temporary cover for a landfill refuse layer comprising the steps of:
providing a filler material;
providing a concentrate including a hardening agent, an emulsifier and thickener and a super absorbent polymer;
mixing said concentrate with said filler material and water to provide a sprayable liquefied composition; and
spraying said composition onto said surface of said refuse layer to provide at least a temporary cover for said refuse layer.

20. The method set forth in claim 19 including the step of:
providing said hardening agent as a Plaster of Paris composition.

21. The method set forth in claim 19 including the step of:
providing said thickener and emulsifier as a guar gum composition.

22. The method set forth in claim 19 including the step of:
providing said super absorbent polymer as a cross-linked sodium acrylate polymer.

23. The method set forth in claim 19 including the step of:
providing said filler material as a biodegradable material selected from a group consisting of cellulose and wood fiber mulch.

24. The method set forth in claim 19 including the step of:
providing said concentrate in dry bulk containers comprising about 75 to 91 percent by weight of hardening agent, 2.5 to 3.0 percent by weight of thickener and emulsifier, and 2.5 to 3.0 percent by weight of super absorbent polymer.
